(19) United States
(12) Patent Application Publication
(10) Pub. No.: US 2026/0081197 A1
(43) Pub. Date: Mar. 19, 2026

(54) FUEL CELL

(71) Applicant: TOYOTA JIDOSHA KABUSHIKI KAISHA, Toyota-shi (JP)

(72) Inventors: Nobuaki NONOYAMA, Chiryu-shi (JP); Yasushi TAKAHASHI, Mishima-shi (JP)

(73) Assignee: TOYOTA JIDOSHA KABUSHIKI KAISHA, Toyota-shi (JP)

(21) Appl. No.: 19/184,249

(22) Filed: Apr. 21, 2025

(30) Foreign Application Priority Data
Sep. 17, 2024 (JP) 2024-160309

(51) Int. Cl. H01M 8/2483; H01M 8/0256; H01M 8/1004; H01M 8/10

(52) U.S. Cl. CPC H01M 8/2483; H01M 8/0256; H01M 8/1004; H01M 2008/1095

(57) ABSTRACT

The fuel cell includes a resin frame body having an opening portion, a membrane electrode assembly disposed in the opening, and a first separator and a second separator opposed to each other via the frame body and the membrane electrode assembly. A first manifold hole is formed in the frame body, the first separator, and the second separator. A plurality of first gas passages extending from the first manifold hole to the membrane electrode assembly are opened in a first region that is a part of the inner peripheral face of the first manifold hole. The first gas passages are formed between the frame body and the first separator. In the first region, in the cross section passing through the central axis of the first manifold hole, the inner wall face of the first separator protrudes toward the central axis side than the inner wall face of the frame body.

This application claims priority to Japanese Patent Application No. 2024-160309 filed on September 17, 2024. The disclosure of the above-identified application, including the specification, drawings, and claims, is incorporated by reference herein in its entirety.

### BACKGROUND

### Technical Field

Technology disclosed in the present specification relates to a fuel cell.

### Description of Related Art

Japanese Unexamined Patent Application Publication No. 2019-160655 (JP 2019-160655 A) discloses a fuel cell. The fuel cell has a structure in which a membrane electrode assembly is surrounded by a frame body that is made of resin. The fuel cell also has a structure in which the membrane electrode assembly is held between both cathode and anode separators, along with the frame body. Stacking a manifold hole of the frame body and manifold holes of both separators forms a manifold hole extending along a stacking direction. At an inner peripheral face of the manifold hole, an inner wall face of the frame body protrudes further toward a center side of the manifold hole than inner wall faces of the separators.

### SUMMARY

When water repellency of the inner peripheral face of the manifold hole increases, water droplets tend to remain on the inner peripheral face thereof. This is because the water droplets can exist individually and independently more readily, and accordingly the water droplets become smaller in volume, and are less susceptible to the influence of gravity and gas flow. In the technology of JP 2019-160655 A, the inner wall face of the frame body protrudes from the inner peripheral face of the manifold hole. In general, a frame body that is made of resin has a higher water contact angle (i.e., higher water repellency) than separators that are conductive. Accordingly, water droplets are more likely to remain on the inner peripheral face of the manifold hole due to the inner wall face of the frame body having high water repellency. When the remaining water droplets freeze and a gas passage is blocked, there is a likelihood that reactive gas cannot be supplied to the membrane electrode assembly at the time of starting, and power generation cannot be performed.

The fuel cell disclosed in the present specification includes

a frame body that is made of resin with an opening portion,

a membrane electrode assembly that is disposed in the opening portion, and

a first separator and a second separator that face each other across the frame body and the membrane electrode assembly.

A first manifold hole extending along a stacking direction of the frame body, the first separator, and the second separator, is opened in the frame body and the separators.

In a first region that is a partial region of an inner peripheral face of the first manifold hole, a plurality of first gas passages is opened, extending from the first manifold hole to the membrane electrode assembly.

The first gas passages are fashioned between the frame body and the first separator.

In the first region, in a cross-section passing through a central axis of the first manifold hole, an inner wall face of the first separator protrudes further toward a central axis side than an inner wall face of the frame body.

According to the above configuration, in the first region in which the first gas passages are opened, the inner wall face of the first separator protrudes further than the inner wall face of the frame body. Also, the inner wall face of the first separator is more hydrophilic than the inner wall face of the frame body. Due to this hydrophilicity, in the first region, water droplets adhering to the inner peripheral face of the first manifold hole can be easily connected to each other. Volume of the water droplets increases, and accordingly the water droplets can be readily discharged by gravity or gas flow. The amount of water droplets remaining on the inner peripheral face of the first manifold hole can thus be reduced, and accordingly the first gas passage can be suppressed from being blocked by freezing of the water droplets.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded view of a fuel cell 1;

FIG. 2 is an enlarged top view of the first manifold hole M1o;

FIG. 3 is a partial side view of the inner peripheral face of the first manifold hole M1o;

FIG. 4 is a partial cross-sectional view taken along IV-IV line of FIG. 2;

FIG. 5 is a partial cross-sectional view of a fuel cell 101 according to a comparative embodiment; and

FIG. 6 is a partial cross-sectional view of the second manifold hole M2o.

### DETAILED DESCRIPTION OF EMBODIMENTS

In the cross section passing through the central axis, the inner wall face of the frame body may protrude toward the central axis side than the inner wall face of the second separator.

According to the above configuration, the frame body can be disposed between the inner wall face of the first separator and the inner wall face of the second separator. It is possible to suppress the first separator and the second separator from being short-circuited due to minute foreign matter, deformation, or the like.

The first manifold hole may be a discharge hole for discharging the reactive gas introduced into the membrane electrode assembly.

Compared with the introduction hole of the reactive gas, the discharge hole of the reactive gas has a larger amount of water droplets. This is because water droplets after the reaction are included. According to the above configuration, it is possible to reduce the amount of remaining water droplets in the discharge hole in which a large amount of water droplets are generated. It is possible to more effectively suppress a situation in which the gas passage is blocked by freezing of water droplets.

The frame body, the first separator, and the second separator may further have second manifold holes extending along the stacking direction thereof. A plurality of second gas passages extending from the second manifold hole to the membrane electrode assembly may be opened in the second region, which is a partial region of the inner peripheral face of the second manifold hole. The plurality of second gas passages may be formed between the frame body and the second separator. In the second region, in the cross section passing through the central axis of the second manifold hole, the inner wall face of the second separator may protrude toward the central axis side than the inner wall face of the frame body.

According to the above configuration, in the second region in which the second gas passage is opened, the inner wall face of the second separator protrudes more than the inner wall face of the frame body. Thus, in the second region, the amount of water droplets remaining on the inner peripheral face of the second manifold hole can be reduced. It is possible to suppress the second gas passage from being blocked by the freezing of the water droplets.

The water contact angle of the first separator and the second separator may be smaller than the water contact angle of the frame body.

According to the above-described configuration, the inner wall faces of the first and second separators are more hydrophilic than the inner wall face of the frame body.

### First Embodiment

### Schematic configuration of the fuel cell 1

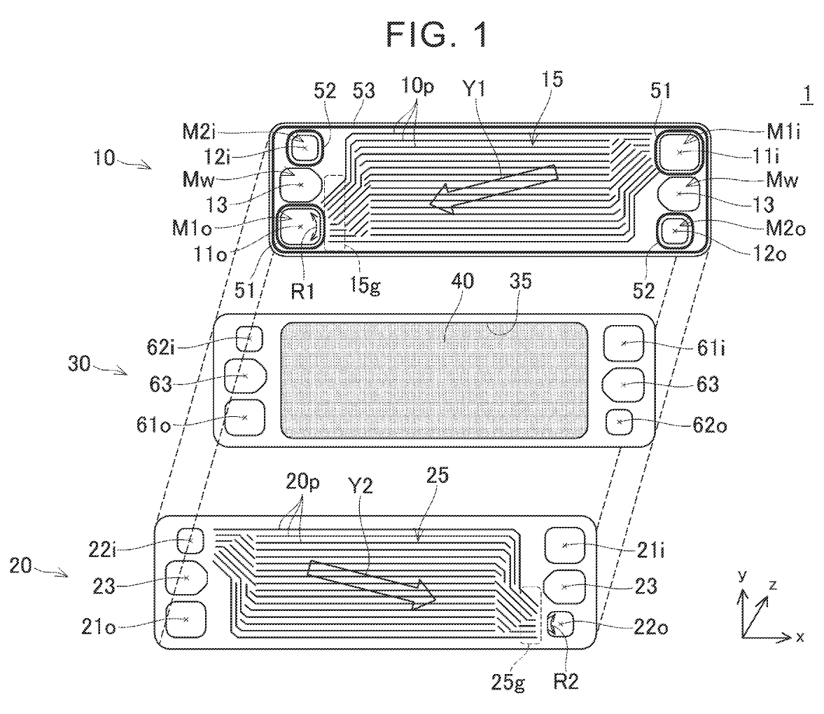

FIG. 1 is an explanatory view showing a fuel cell 1 according to an embodiment of the present disclosure in an exploded state. The fuel cell 1 is a polymer electrolyte fuel cell that generates electric power by being supplied with hydrogen and oxygen. The fuel cell 1 mainly includes a first separator 10, a second separator 20, a frame body 30, and a membrane electrode assembly 40.

The frame body 30 is a frame-shaped resin member surrounding the entire periphery of the membrane electrode assembly 40. In the present embodiment, for example, polyethylene naphthalate (PEN) is used as the resinous member. However, as the resin member, various other resin members and rubber materials such as polypropylene, polyethylene, polyethylene terephthalate, and polyphenylene sulfide can also be used.

The frame body 30 includes an opening portion 35 in the central region that surrounds and houses the membrane electrode assembly 40. The membrane electrode assembly 40 is disposed in the opening portion 35. In FIG. 1, the membrane electrode assembly 40 is shown with a gray fill. The structure of the membrane electrode assembly 40 will be described later. The frame body 30 includes manifold holes 61i, 61o, 62i, 62o and 63 on the left and right sides (±x-direction sides) of the opening portion 35.

The first separator 10 and the second separator 20 face each other via the frame body 30 and the membrane electrode assembly 40. The first separator 10 and the second separator 20 have conductivity. The first separator 10 and the second separator 20 may be formed, for example, by press-molding a metal plate made of stainless steel, titanium, or an alloy thereof, or may be formed of a carbon resin composite material or the like. In the present embodiment, the first separator 10 and the second separator 20 are formed of a carbon resin composite material.

In the present embodiment, the first separator 10 is a cathode-side separator, and the second separator 20 is an anode-side separator. The first separators 10 are provided with manifold holes 11i, 11o, 12i, 12o and 13 in their outer edge regions. The second separators 20 are provided with manifold holes 21i, 21o, 22i, 22o and 23 in their outer edge regions.

The manifold holes 11i, 61i, 21i are stacked on each other to form a first manifold hole M1i which is used for supplying the reactive gases (air). The manifold holes 11o, 61o, 21o are stacked on each other to form a first manifold hole M1o that is used for discharging the reactive gases. The manifold holes 12i, 62i, 22i are stacked on each other to form a second manifold hole M2i which is used for supplying the reactive gases. By stacking the manifold holes 12o, 62o, 22o together, a second manifold hole M2o used for discharging the reactive gases is formed. By laminating the manifold holes 13, 63, and 23 to each other, a coolant manifold hole Mw forming a coolant channel is formed. Since the specific configuration of the coolant channel is not directly related to the gist of the technology of the present specification, a detailed description thereof will be omitted. The first manifold holes M1i and M1o, the second manifold holes M2i and M2o, and the coolant manifold holes Mw extend along the stacking direction (z direction).

The first separator 10 includes a flow path 15 extending from the first manifold hole M1i to M1o. The flow path 15 is formed by the uneven portion 10p of the lower surface of the first separator 10 (that is, the surface facing the frame body 30). The content of the uneven portion 10p will be described later. The reactive gas (air) flowing into the first manifold hole M1i passes through the membrane electrode assembly 40 via the flow path 15, and is discharged from the first manifold hole M1o (see the arrow Y1 in FIG. 1).

Similarly, the second separator 20 includes a flow path 25 extending from the second manifold hole M2i to M2o. The flow path 25 is formed by the uneven portion 20p of the upper surface (that is, the surface facing the frame body 30) of the second separator 20. The reactive gas (hydrogen) flowing into the second manifold hole M2i passes through the membrane electrode assembly 40 via the flow path 25 and is discharged from the second manifold hole M2o (see the arrow Y2 in FIG. 1).

Gaskets 51, 52, and 53 are disposed on the upper surface of the first separator 10. The gaskets 51, 52, and 53 are made of, for example, silicone rubber. The gasket 51 is arranged so as to surround each of the manifold holes 11i and 11o. When the plurality of fuel cells 1 are stacked, the sealability of the first manifold holes M1i and M1o is ensured by the gasket 51. Similarly, the gasket 52 is arranged to surround each of the manifold holes 12i and 12o. When the plurality of fuel cells 1 are stacked, the sealability of the second manifold holes M2i and M2o is ensured by the gasket 52. The gasket 53 is disposed so as to surround the outer periphery of the first separator 10.

### Construction of the first manifold hole M1o

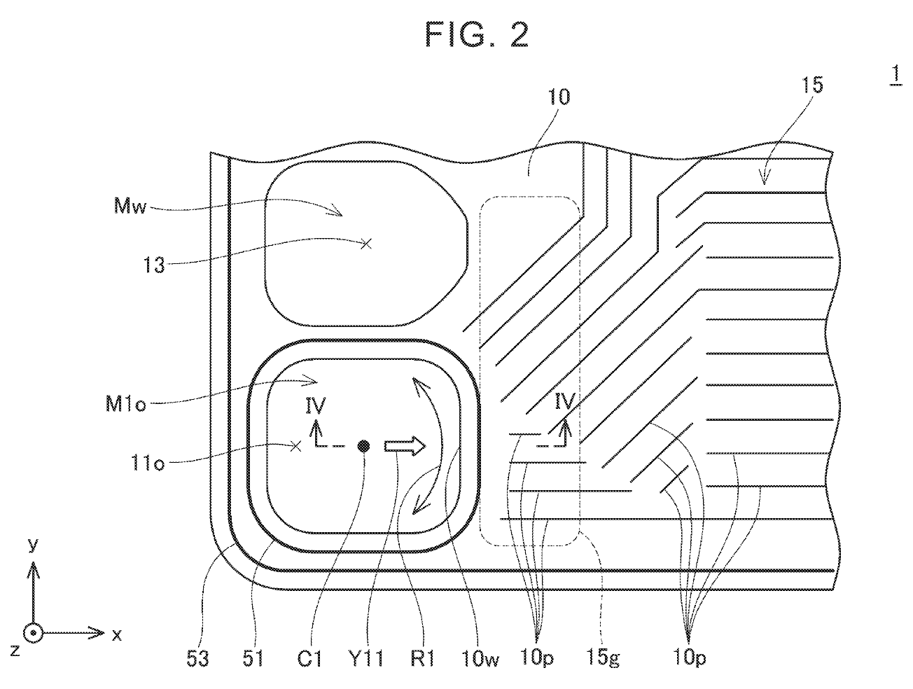

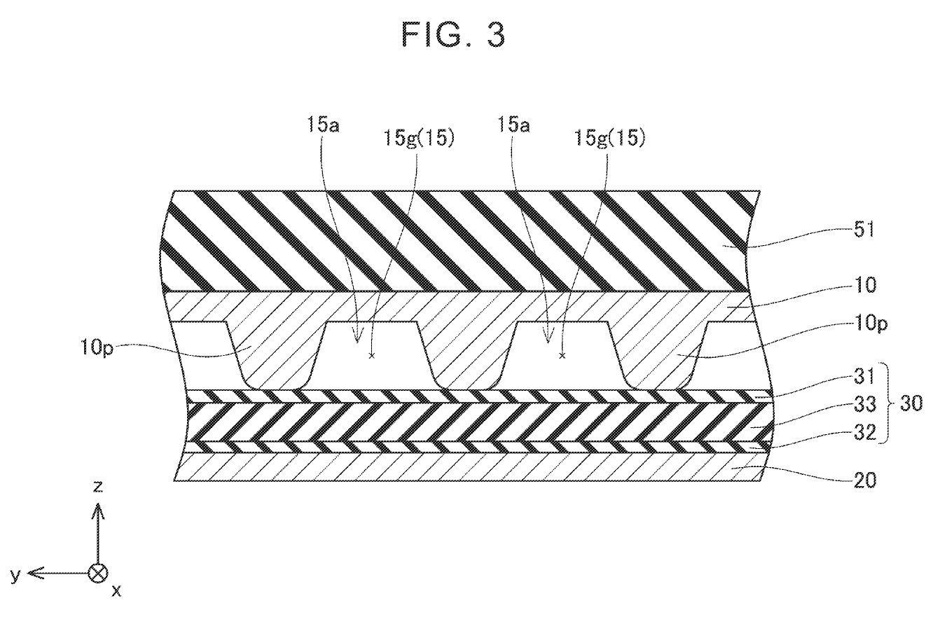

FIG. 2 is an enlarged top view of the first manifold hole M1o in the fuel cell 1. The first manifold hole M1o is a manifold hole for discharging air, which is disposed at a lower left portion of the fuel cell 1 of FIG. 1. FIG. 3 is a partial side view when the inner peripheral face of the first manifold hole M1o is viewed from the arrow Y11 of FIG. 2. Although FIG. 3 is a side view, hatching is used to make the opening portion 15a easy to understand.

The flow path 15 includes a plurality of first gas passage 15g. As shown in FIG. 3, the plurality of first gas passages 15g are formed between the frame body 30 and the first separators 10. That is, the uneven portion 10p contacts the upper surface of the frame body 30, so that the first gas passage 15g is formed between the adjoining uneven portions 10p. Therefore, in the first gas passage 15g, the side wall is formed of the uneven portion 10p, the upper inner wall is formed of the first separator 10, and the lower inner wall is formed of the frame body 30.

As shown in FIG. 2, the plurality of first gas passages 15g extend from the first manifold hole M1o to the membrane electrode assembly 40. In addition, the terminal opening portions of the plurality of first gas passages 15g are disposed in the first region R1 on the inner peripheral face of the first manifold hole M1o. Therefore, as shown in FIG. 3, in the first region R1, the opening portion 15a of the first gas passage 15g is exposed on the inner peripheral face of the first manifold hole M1o.

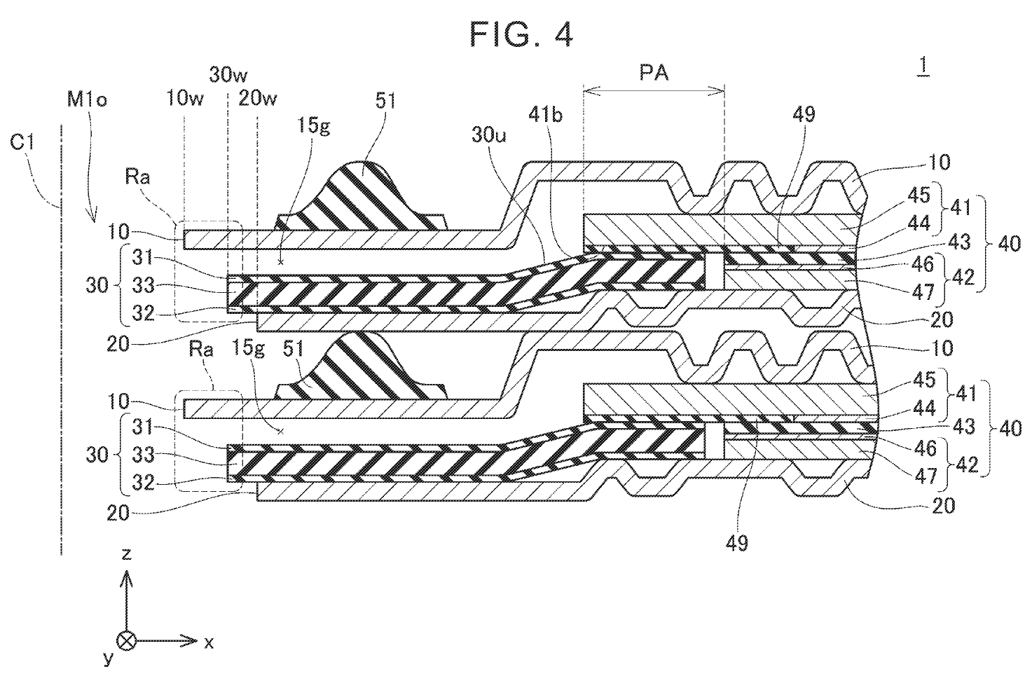

FIG. 4 is a partial cross-sectional view taken along IV-IV line of FIG. 2. FIG. 4 is a cross-sectional view through the central axis C1 of the first manifold hole M1o and through the first gas passage 15g. FIG. 4 shows a state in which two fuel cells 1 are stacked. The membrane electrode assembly 40 includes an oxygen electrode 41, a hydrogen electrode 42, and an electrolyte membrane 43. The electrolyte membrane 43 is an ion exchange membrane formed of a solid polymer material and having proton conductivity. The oxygen electrode 41 includes a first catalyst layer 44 and a first gas diffusion layer 45. The hydrogen electrode 42 includes a second catalyst layer 46 and a second gas diffusion layer 47. The first catalyst layer 44 and the second catalyst layer 46 are porous layers in which carbon particles or metal oxides on which a catalyst is supported are connected by a resin. The first gas diffusion layer 45 and the second gas diffusion layer 47 are conductive members having water permeability and gas permeability. Since a well-known structure can be applied to the membrane electrode assembly 40, a detailed description thereof will be omitted.

A flange-shaped outer peripheral region PA is formed on the outer periphery of the membrane electrode assembly 40 by the oxygen electrode 41. In the outer peripheral region PA, an adhesive layer 49 is disposed on the lower surface 41b of the oxygen electrode 41. The adhesive layer 49 is a layer formed of an adhesive. Examples of the adhesive include an adhesive having ultraviolet curability and a hot melt. The lower surface 41b of the oxygen-electrode 41 is fixed to the upper surface 30u of the frame body 30 by the adhesive layers 49.

The frame body 30 has a three-layer structure in which the first resin layer 31, the core layer 33, and the second resin layer 32 are laminated in the thickness direction. The core layer 33 is a structural member having gas sealing properties and insulating properties. The first resin layer 31 is a layer bonded to the first separator 10. The second resin layer 32 is a layer bonded to the second separator 20.

The first resin layer 31 and the second resin layer 32 may have lower melting points than the core layer 33. Specifically, the first resin layer 31 and the second resin layer 32 may be thermoplastic resins such as acid-modified olefin resins and polyester resins. Note that the frame body 30 having a multilayer structure can be formed by various methods. For example, it may be formed by co-extrusion.

The inner wall face 10w of the first separator 10 protrudes from the inner wall face 30w of the frame body 30 toward the central axis C1 (toward-x) (see region Ra). Further, the inner wall face 30w of the frame body 30 protrudes toward the central axis C1 from the inner wall face 20w of the second separator 20. That is, the protrusion amount toward the central axis C1 is large in the order of the inner wall face 10w, 30w, 20w.

The water contact angle of the first separator 10 and the second separator 20 is smaller than the water contact angle of the frame body 30. For example, the water contact angle of the first separator 10 and the second separator 20 may be smaller than 90°, and the water contact angle of the frame body 30 may be larger than 90°. That is, the inner wall face 10w of the first separator 10 and the inner wall face 20w of the second separator 20 are more hydrophilic than the inner wall face 30w of the frame body 30. This is because the frame body 30 has water repellency due to the inherent properties of the resin member described above. This is because the first separator 10 and the second separator 20 have hydrophilicity due to the inherent properties of the above-described conductive material. Here, the hydrophilicity refers to hydrophilicity in a power generation environment of a fuel cell (an environment in which water droplets are present in a high-temperature and high-humidification state).

### Issues

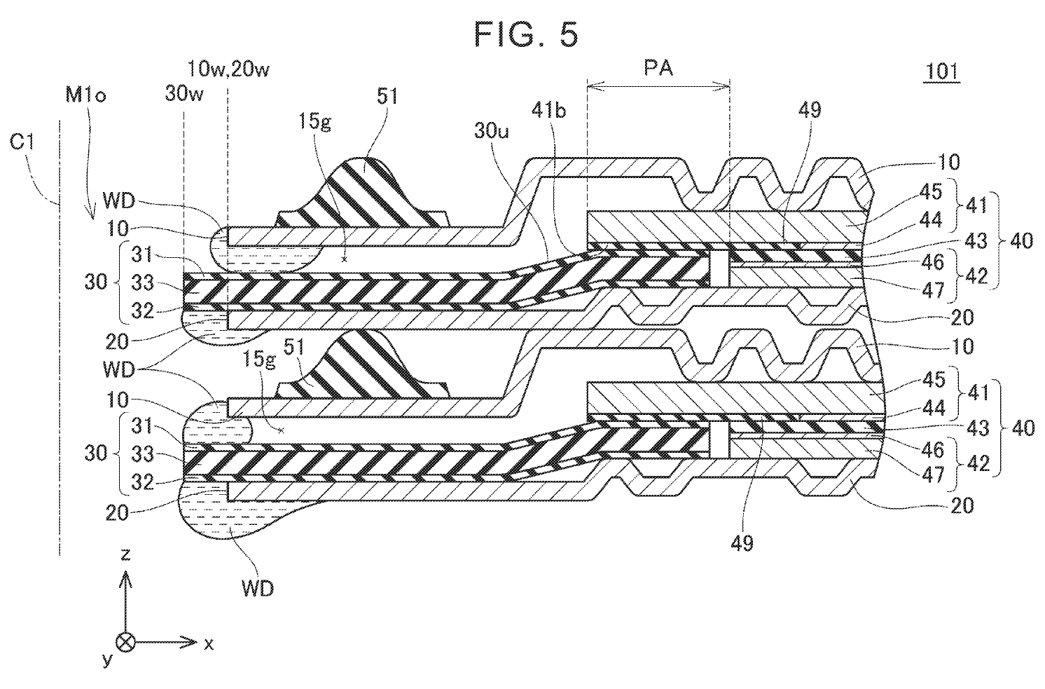

Problems will be described using the fuel cell 101 of the comparative example of FIG. 5. The fuel cell 101 (FIG. 5) of the comparative example differs from the fuel cell 1 (FIG. 4) of the present example in the positional relation of the inner wall face 10w, 20w, 30w. Specifically, the inner wall face 30w of the frame body 30 protrudes toward the central axis C1 (-x side) from the inner wall face 10w of the first separator 10 and the inner wall face 20w of the second separator 20. Since the other structures of the fuel cell 101 of the comparative example are the same as those of the fuel cell 1 of the present embodiment, the description thereof will be omitted.

In the fuel cell 101 of the comparative embodiment (FIG. 5), the inner wall face 30w of the frame body 30 protrudes from the inner peripheral face of the first manifold hole M1o. As described above, the frame body 30 has a larger water contact angle than the first separator 10 and the second separator 20 (i.e., has a higher water repellency). Therefore, due to 30w of the inner wall face of the highly water-repellent frame body 30, the water droplet WD tends to remain on the inner peripheral face of the first manifold hole M1o. This is because the water repellency of the inner peripheral face of the first manifold hole M1o is increased, so that the water droplet WD is easily independently present. This is because the volume of the water droplet WD becomes smaller and is less susceptible to gravitational force and gas flow. When the remaining water droplet WD is frozen and the first gas passage 15g is blocked, the gas cannot be supplied/discharged to the membrane electrode assembly 40 at the time of starting, and it becomes difficult to generate electric power.

### Effects

In the fuel cell 1 (FIG. 4) of the present embodiment, the inner wall face 10w of the first separator 10 protrudes toward the central axis C1 from the inner wall face 30w of the frame body 30 (see region Ra). Thus, in the first region R1 (the region where the opening portion 15a of the first gas passage 15g is disposed), the relatively hydrophilic member can be exposed to the inner peripheral face of the first manifold hole M1o. Due to this hydrophilicity, in the first region R1, the water droplets adhering to the inner peripheral face of the first manifold hole M1o can be easily connected to each other. Volume of the water droplets increases, and accordingly the water droplets can be readily discharged by gravity or gas flow. Since the quantity of water droplets remaining on the inner peripheral face of the first manifold hole M1o can be reduced, the first gas passage 15g can be prevented from being blocked by freezing of the water droplets. It is possible to improve the startability of the fuel cell 1 below the freezing point.

Since a part of the first gas passage 15g is formed by the first separator 10, the inner wall face 10w of the first separator 10 is located in the vicinity of the first gas passage 15g. Therefore, if water droplets remain around the inner wall face 10w, the remaining water droplets may be sucked into the first gas passage 15g, and the first gas passage 15g may be blocked. Therefore, in the fuel cell 1 of the present embodiment, the inner wall face 10w of the first separator 10 protrudes from the inner wall face 30w of the frame body 30 (see the region Ra). Accordingly, it is possible to prevent the flow of the gas from staying in the vicinity of the inner wall face 10w, and thus it is possible to easily discharge the water droplets. It is possible to suppress the first gas passage 15g from being blocked.

When both of the inner wall face 10w of the first separator 10 and the inner wall face 20w of the second separator 20 protrude from the inner wall face 30w of the frame body 30 toward the central axis C1, a region where the frame body 30 is not present is formed between the inner wall face 10w and 20w. In this case, both separators may be short-circuited due to contamination of foreign matters, deformation of the separator, or the like. Therefore, in the fuel cell 1 of the present embodiment, the inner wall face 30w of the frame body 30 protrudes toward the central axis C1 from the inner wall face 20w of the second separator 20. Accordingly, the insulating frame body 30 can be disposed between the inner wall face 10w of the first separator 10 and the inner wall face 20w of the second separator 20. The frame body 30 can suppress the first separator 10 and the second separator 20 from being short-circuited.

The first manifold hole M1o, which is the discharge hole of the reactive gas, has a larger volume of water droplets than the first manifold hole M1i, which is the introduction hole of the reactive gas. This is because water droplets after the reaction are included. In the fuel cell 1 of the present embodiment, the hydrophilic member (the inner wall face 10w of the first separator 10) protrudes from the inner peripheral face of the discharge-side first manifold hole M1o. Therefore, the first gas passage 15g can be prevented from being blocked because the amount of residual water droplets can be reduced on the inner peripheral face of the discharge-side first manifold hole M1o in which a large amount of water droplets are generated.

### Modification of the first embodiment

The above-described configuration of the first manifold hole M1o on the discharge side is also applicable to the first manifold hole M1i on the introduction side. That is, in the first manifold hole M1i, the inner wall face 10w of the first separator 10 may protrude more than the inner wall face 30w of the frame body 30.

10w protruding from the inner wall face 30w (see region Ra) may not be formed on the entire circumference of the inner peripheral face of the first manifold hole M1o, and may be formed at least in the first region R1 (FIG. 2). The region other than the first region R1 is a region far from the first gas passage 15g. This is because even if water droplets are present in the region area, there is little risk of blocking the first gas passage 15g.

A structure (see region Ra) protruding 10w the inner wall face 30w may not be formed in the entire region of the first region R1 (FIG. 2), but may be formed in at least a part of the region. As a result, it is possible to suppress the first gas passage 15g from being completely blocked by freezing of the water droplets. At least a part of the first gas passage 15g is opened, so that the fuel cell 1 can be started.

### Second Embodiment

In the second embodiment, the configuration of the second manifold hole M2o will be described. The second manifold hole M2o is a manifold hole for discharging hydrogen, which is arranged at the lower right side of the fuel cell 1 in FIG. 1.

As shown in FIG. 1, the flow path 25 includes a plurality of second gas passages 25g. The plurality of second gas passages 25g are formed between the frame body 30 and the second separators 20. The plurality of second gas passages 25g extend from the second manifold hole M2o to the membrane electrode assembly 40. In addition, the end opening portions of the plurality of second gas passages 25g are formed in the second regions R2 on the inner peripheral face of the second manifold hole M2o.

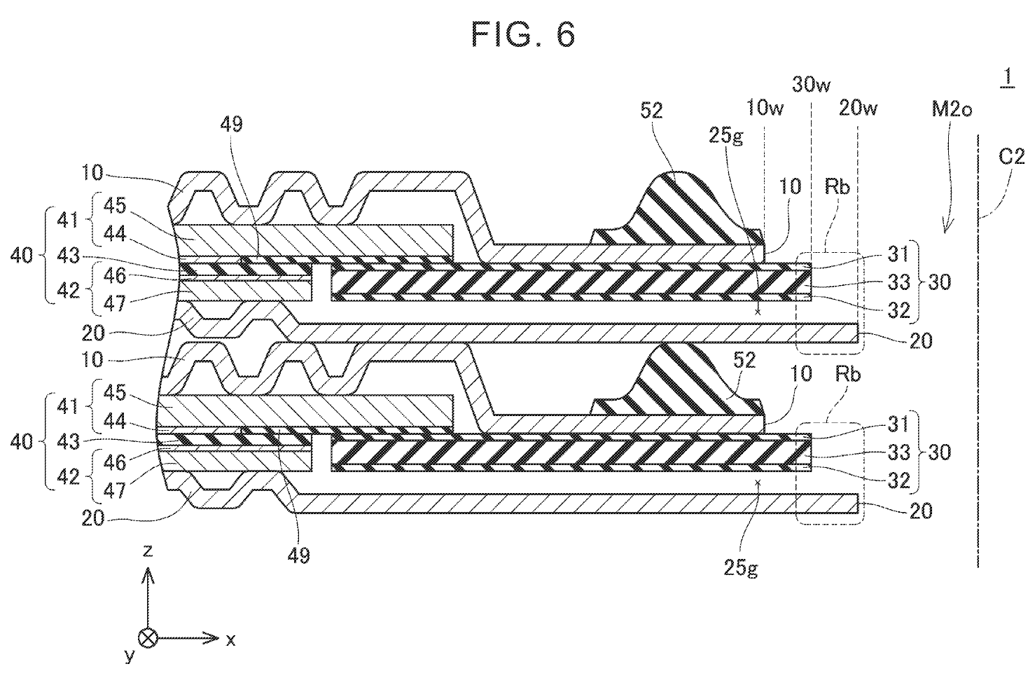

FIG. 6 is a cross-sectional view of the second manifold hole M2o. FIG. 6 is a cross-sectional view through the central axis C2 of the second manifold hole M2o and through the second region R2. Parts common to the first embodiment (FIG. 4) and the second embodiment (FIG. 6) are denoted by the same reference numerals, and description thereof will be omitted.

The inner wall face 20w of the second separator 20 protrudes from the inner wall face 30w of the frame body 30 toward the central axis C2 (+x-direction side) (see region Rb). Further, the inner wall face 30w of the frame body 30 protrudes toward the central axis C2 from the inner wall face 10w of the first separator 10. That is, the protrusion amount toward the central axis C2 is large in the order of the inner wall face 20w, 30w, 10w.

### Effects

The inner wall face 20w of the second separator 20 protrudes toward the central axis C2 from the inner wall face 30w of the frame body 30 (see region Rb). Accordingly, in the second region R2 (the region where the opening portion of the second gas passage 25g is disposed), the relatively hydrophilic member can be exposed to the inner peripheral face of the second manifold hole M2o. Since the quantity of water droplets remaining on the inner peripheral face of the second manifold hole M2o can be reduced, the second gas passage 25g can be prevented from being blocked by the freezing of the water droplets.

Since a part of the second gas passage 25g is formed by the second separator 20, the inner wall face 20w of the second separator 20 is located in the vicinity of the second gas passage 25g. In the fuel cell 1 of the present embodiment, it is possible to prevent the flow of gas from staying in the vicinity of the inner wall face 20w by making the inner wall face 20w of the second separator 20 protrude from the inner wall face 30w of the frame body 30. It is possible to suppress the second gas passage 25g from being blocked.

Although the embodiments have been described in detail above, these are merely examples and do not limit the scope of the claims. The technique described in the claims includes various modifications and variations of the specific examples exemplified above. The technical elements described in this specification or in the drawings may be used alone or in various combinations, and are not limited to the combinations described in the claims at the time of filing. Further, the technology illustrated in the present specification or the drawings achieves a plurality of objects at the same time, and has technical usefulness by achieving one of the objects.

### Modification

The technology of the present specification can be applied to any of an air-cooled fuel cell and a water-cooled fuel cell.

In the present embodiment, the shapes of the first manifold holes M1i and M1o, the second manifold holes M2i and M2o, and the coolant manifold holes Mw are rectangular in the drawing, but the shape may be a manifold hole having an opening shape of a triangular shape, a polygonal shape, or a deformed shape.

What is claimed is:

1. A fuel cell, comprising:
a frame body that is made of resin with an opening portion;
a membrane electrode assembly that is disposed in the opening portion; and
a first separator and a second separator that face each other across the frame body and the membrane electrode assembly, wherein
a first manifold hole extending along a stacking direction of the frame body, the first separator, and the second separator, is opened in the frame body and the separators,
in a first region that is a partial region of an inner peripheral face of the first manifold hole, a plurality of first gas passages is opened, extending from the first manifold hole to the membrane electrode assembly,
the first gas passages are fashioned between the frame body and the first separator, and
in the first region, in a cross-section passing through a central axis of the first manifold hole, an inner wall face of the first separator protrudes further toward a central axis side than an inner wall face of the frame body.

2. The fuel cell according to claim 1, wherein, in a cross-section passing through the central axis, the inner wall face of the frame body protrudes further toward the central axis side than an inner wall face of the second separator.

3. The fuel cell according to claim 1, wherein the first manifold hole is a discharge hole for discharging reactive gas that is introduced into the membrane electrode assembly.

4. The fuel cell according to claim 1, wherein
a second manifold hole extending along the stacking direction of the frame body, the first separator, and the second separator, is further opened in the frame body and the separators,
in a second region that is a partial region of an inner peripheral face of the second manifold hole, a plurality of second gas passages is opened extending from the second manifold hole to the membrane electrode assembly,
the second gas passages are fashioned between the frame body and the second separator, and
in the second region, in a cross-section passing through a central axis of the second manifold hole, the inner wall face of the second separator protrudes further toward the central axis side than the inner wall face of the frame body.

5. The fuel cell according to claim 1, wherein a water contact angle of the first separator and the second separator is smaller than a water contact angle of the frame body.
